(19) United States
(12) Patent Application Publication
(10) Pub. No.: US 2014/0189960 A1
(43) Pub. Date: Jul. 10, 2014

(54) Use of a Combination of Secondary Paraffin Sulfonate and Amylase for Increasing the Cleaning Capacity of Liquid Detergents

(71) Applicants: Johannes Himmrich, Eppstein (DE); Barbara Duecker, Mainz (DE); Joachim Erbes, Frankfurt am Main (DE); Stefan Riegelbeck, Frankfurt (DE)

(72) Inventors: Johannes Himmrich, Eppstein (DE); Barbara Duecker, Mainz (DE); Joachim Erbes, Frankfurt am Main (DE); Stefan Riegelbeck, Frankfurt (DE)

(73) Assignee: CLARIANT INTERNATIONAL LTD., Muttenz (CH) (CH)

(21) Appl. No.: 14/131,706

(22) PCT Filed: Jul. 7, 2012
(86) PCT No.: PCT/EP2012/002869

§ 371 Date: Jan. 31, 2014

(30) Foreign Application Priority Data
Jul. 12, 2011 (DE) 10 2011 107 116.8

(51) Int. Cl. C11D 3/34

(52) U.S. Cl. CPC C11D 3/3463
USPC 8/137

(57) ABSTRACT

An improvement for boosting the cleaning capacity of liquid washing compositions provides for the use of a combination of one or more secondary paraffinsulfonates having 8 to 22 carbon atoms and amylase for increasing the cleaning capacity of the liquid washing compositions with respect to starch-containing stains on textiles. In accordance with the invention, it is possible to lower the amount of liquid washing composition with comparable cleaning performance, which brings environmental advantages. Moreover, it is possible to clean at low temperatures, which can reduce energy consumption.

### CLAIM FOR PRIORITY

This application is a National Stage Application based on PCT/EP2012/002869 which is based on German Application DE 10 2011 107 116.8. The priorities of the foregoing applications are hereby claimed and their disclosures incorporated herein by reference.

### TECHNICAL FIELD

The invention relates to the use of a combination of secondary paraffinsulfonate and amylase for increasing the cleaning capacity of liquid washing compositions with respect to starch-containing stains on textiles.

### BACKGROUND

The use of enzymes in washing and cleaning compositions, and especially in washing compositions for textiles, for example against oil- and grease-containing, protein-containing or starch-containing stains, is already known.

However, there is still a need to further improve the cleaning capacity of liquid washing compositions with respect to starch-containing stains.

### SUMMARY OF INVENTION

It has been found that, surprisingly, the cleaning capacity of liquid washing compositions with respect to starch-containing stains on textiles can be increased when amylase is combined with one or more secondary paraffinsulfonates having 8 to 22 carbon atoms.

The present invention therefore provides for the use of a combination of one or more secondary paraffinsulfonates having 8 to 22 carbon atoms and amylase for increasing the cleaning capacity of liquid washing compositions with respect to starch-containing stains on textiles.

The inventive use brings, for example, the advantage that it is possible to lower the amount of liquid washing composition with comparable cleaning performance, which brings environmental advantages. Moreover, it is possible to clean at low temperatures, which can reduce energy consumption.

Secondary paraffinsulfonates have long been known, for example as a base surfactant for washing composition applications.

It is also known, for example from the Clariant brochure from May 2000 “A traditional speciality for innovative cleaners”, with regard to Hostapur® SAS, a secondary paraffinsulfonate, that both enzymes and secondary paraffinsulfonate can be used together, for example in liquid washing compositions. It is additionally known from this Clariant brochure that secondary paraffinsulfonates such as Hostapur® SAS can stabilize enzymes, for example proteases or lipases, and give rise to better enzyme compatibilities in formulations, for example in liquid washing compositions, than most anionic surfactants, for example linear alkylbenzenesulfonates (LAS) or alkyl-sulfates. It is also stated therein that the use of Hostapur® SAS in liquid washing compositions can reduce the amount of enzyme.

The secondary paraffinsulfonates can be prepared by sulfoxidation of paraffins under photochemical conditions and are available on the market, for example, under the Hostapur® SAS trade name in the concentrations of 30% by weight, 60% by weight and 93% by weight.

Preferably, at least 95% by weight, more preferably at least 97% by weight, of the one or more secondary paraffinsulfonates contain 14 to 17 carbon atoms.

Preferably, 95 to 100% by weight, more preferably 96 to 99.9% by weight, of the one or more secondary paraffinsulfonates contain a linear paraffin moiety and 0 to 5% by weight, more preferably 0.1 to 4% by weight, of the one or more secondary paraffinsulfonates a branched paraffin moiety.

Preferably, the counterions of the one or more secondary paraffinsulfonates are selected from the group consisting of Na⁺, K⁺, Mg²⁺ and Ca²⁺. More preferably, the counterion of the one or more secondary paraffinsulfonates is Na⁺.

Preferably, 99.5 to 100% by weight of the one or more secondary paraffinsulfonates contain a saturated paraffin moiety and 0 to 0.5% by weight of the one or more secondary paraffinsulfonates an unsaturated paraffin moiety. More preferably, 100% by weight of the one or more secondary paraffinsulfonates contain a saturated paraffin moiety and no unsaturated components.

### DETAILED DESCRIPTION

In the context of the present invention, “secondary paraffinsulfonate” means that the sulfonate groups are bonded to the nonterminal paraffin moiety.

Preferably, the sulfonate groups are distributed randomly over the nonterminal paraffin moiety of the one or more secondary paraffinsulfonates, and additionally preferably from 75 to 95% by weight of the one or more secondary paraffinsulfonates bear one sulfonate group and from 5 to 25% by weight of the one or more secondary paraffinsulfonates two or more sulfonate groups.

Examples of amylases available include Steinzyme® Plus 12L, Termamyl®, Amylase® LT, Maxamyl®, Duramyl® and/or Pruafect® Ox.

As well as the one or more secondary paraffinsulfonates and the one or more enzymes, the liquid washing compositions may comprise one or more standard ingredients, such as further surfactants (other than the secondary paraffinsulfonates), emulsifiers, builders, bleach catalysts and activators, sequestrants, soil release polymers, graying inhibitors, dye transfer inhibitors, dye fixatives, complexing agents, optical brighteners, softening components, dyes and/or fragrances.

The total amount of surfactants in the liquid washing compositions may preferably be from 1 to 99% by weight, more preferably from 5 to 80% by weight, especially preferably from 10 to 70% by weight and exceptionally preferably from 20 to 60% by weight, based in each case on the total weight of the finished liquid washing compositions.

The surfactants used in the liquid washing compositions may be anionic, nonionic, amphoteric or cationic. It is also possible to use mixtures of the surfactants mentioned. Preferred liquid washing compositions comprise anionic and/or nonionic surfactants and mixtures thereof with further surfactants.

Examples of useful anionic surfactants include sulfates, sulfonates, carboxylates, phosphates and mixtures thereof. Suitable cations in this context are, for example, alkali metals, for example sodium or potassium, or alkaline earth metals, for example magnesium, and also ammonium, substituted ammonium compounds, including mono-, di- or triethanolammonium cations, and mixtures thereof.

The following types of anionic surfactants are of particular interest: ester sulfonates, sulfates, ether sulfates, substituted benzenesulfonates, sulfonates and soaps.

Preferred ester sulfonates are compounds of the formula

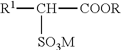

in which R¹ is a C₈-C₂₀ hydrocarbyl radical, preferably alkyl, and R is a C₁-C₆ hydrocarbyl radical, preferably alkyl. M is a cation which forms a water-soluble salt with the ester sulfonate. Suitable cations are sodium, potassium, lithium or ammonium cations, such as monoethanolamine, diethanolamine and triethanolamine. Particular preference is given to methyl ester sulfonates in which R¹ is C₁₀-C₁₆-alkyl and R is methyl.

Sulfates here are water-soluble salts or acids of the formula ROSO₃M in which R is a C₁₀-C₂₄ hydrocarbyl radical, preferably an alkyl or hydroxyalkyl radical with a C₁₀-C₂₀-alkyl component, more preferably a C₁₂-C₁₈-alkyl or -hydroxyalkyl radical. M is hydrogen or a cation, for example an alkali metal cation (e.g. sodium, potassium, lithium) or ammonium or substituted ammonium.

Ether sulfates are water-soluble salts or acids of the formula RO(A)ₘSO₃M in which R is an unsubstituted C₁₀-C₂₄ hydrocarbyl radical, preferably C₁₀-C₂₄-alkyl radical, or a C₁₀-C₂₄ hydrocarbyl radical substituted by a hydroxyl group, preferably C₁₀-C₂₄-hydroxyalkyl radical, more preferably a C₁₂-C₂₀-alkyl or -hydroxyalkyl radical, especially preferably C₁₂-C₁₈-alkyl or -hydroxyalkyl radical. A is an ethoxy (E0) or propoxy (PO) unit, m is a number greater than 0, preferably between 0.5 and 6, more preferably between 0.5 and 3, and M is a hydrogen atom or a cation, for example sodium, potassium, lithium, calcium, magnesium, ammonium or a substituted ammonium cation. Examples include C₁₂ to C₁₈ fatty alcohol ether sulfates, where the EO content is 1, 2, 2.5, 3 or 4 mol per mole of the fatty alcohol ether sulfate, and in which M is sodium or potassium.

Further suitable anionic surfactants are alkenyl- or alkylbenzenesulfonates. The alkenyl or alkyl group may be linear or branched and may optionally be substituted by a hydroxyl group. The preferred alkyl-benzenesulfonates contain linear alkyl chains having 9 to 25 carbon atoms and preferably having 10 to 13 carbon atoms; the cation is sodium, potassium, ammonium, mono-, di- or triethanolammonium, calcium, magnesium or a mixture thereof. Magnesium is a preferred cation for mild surfactant systems, but sodium for standard washing applications. The same applies to alkenylbenzenesulfonates.

As well as the secondary paraffinsulfonates used in accordance with the invention, it is also possible to use primary sulfonates in the liquid washing compositions.

The primary sulfonates are preferably alkane- or alkenesulfonates, where the alkyl or alkenyl group is either branched or linear and may optionally be substituted by a hydroxyl group. The preferred primary sulfonates contain linear alkyl or alkenyl chains having 9 to 25 carbon atoms, preferably having 10 to 20 carbon atoms and more preferably having 13 to 17 carbon atoms. The cation is, for example, sodium, potassium, ammonium, mono-, di- or triethanolammonium, magnesium, or a mixture thereof. Sodium is a preferred cation.

The preparation of primary alkanesulfonic acid, from which the corresponding sulfonates active as surfactants can be obtained, is described, for example, in EP 854 136 A1.

The term “anionic surfactants” also includes olefin-sulfonates which are obtained by sulfonation of C₁₂-C₂₄, preferably C₁₄-C₁₆, α-olefins with sulfur trioxide and subsequent neutralization. As a result of the preparation process, these olefinsulfonates may contain relatively small amounts of hydroxyalkanesulfonates and alkanedisulfonates. Specific mixtures of α-olefin-sulfonates are described in U.S. Pat. No. 3,332,880.

Further preferred anionic surfactants are carboxylates, for example fatty acid soaps and comparable surfactants. The soaps may be saturated or unsaturated and may contain various substituents, such as hydroxyl groups or α-sulfonate groups. Preference is given to linear saturated or unsaturated hydrocarbyl radicals as the hydrophobic component having 6 to 30 and preferably 10 to 18 carbon atoms.

Examples of useful nonionic surfactants include the following compounds:

polyethylene, polypropylene and polybutylene oxide condensates of alkylphenols:

These compounds include the condensation products of alkyl phenols having a C₆- to C₂₀-alkyl group, which may either be linear or branched, with alkene oxides. These surfactants are referred to as alkylphenol alkoxylates, e.g. alkylphenol ethoxylates.

Condensation products of aliphatic alcohols with 1 to 25 mol of ethylene oxide:

The alkyl or alkenyl chain of the aliphatic alcohols may be linear or branched, primary or secondary, and contains generally 8 to 22 carbon atoms. Particular preference is given to the condensation products of C₁₀ to C₂₀ alcohols with 2 to 18 mol of ethylene oxide per mole of alcohol. The alcohol ethoxylates may have a narrow (“narrow range ethoxylates”) or a broad homolog distribution of the ethylene oxide (“broad range ethoxylates”). Examples of commercially available nonionic surfactants of this type are Tergitol® 15-S-9 (condensation product of a linear secondary C₁₁-C₁₅ alcohol with 9 mol of ethylene oxide), Tergitol® 24-L-NMW (condensation product of a linear primary C₁₂-C₁₄ alcohol with 6 mol of ethylene oxide, having narrow molar mass distribution). This product class likewise includes the Genapol® brands from Clariant.

Condensation products of ethylene oxide with a hydrophobic basis, formed by condensation of propylene oxide with propylene glycol:

The hydrophobic moiety of these compounds preferably has a molecular weight between 1500 and 1800. The addition of ethylene oxide onto this hydrophobic moiety leads to an improvement in the water solubility. The product is liquid up to a polyoxyethylene content of about 50% of the total weight of the condensation product, which corresponds to a condensation with up to about 40 mol of ethylene oxide. Commercially available examples of this product class are the Pluronic® brands from BASF and the Genapol® PF brands from Clariant.

Condensation products of ethylene oxide with a reaction product of propylene oxide and ethylenediamine:

The hydrophobic unit of these compounds consists of the reaction product of ethylenediamine with excess propylene oxide and generally has a molecular weight of 2500 to 3000. Ethylene oxide is added onto this hydrophobic unit up to a content of 40 to 80% by weight of polyoxyethylene and a molecular weight of 5000 to 11 000. Commercially available examples of this compound class are the Tetronic® brands from BASF and the Genapol® PN brands from Clariant.

Semipolar nonionic surfactants:

This category of nonionic compounds encompasses water-soluble amine oxides of the formula

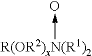

In this formula, R is an alkyl, hydroxyalkyl or alkylphenol group having a chain length of 8 to 22 carbon atoms, R² is an alkylene or hydroxyalkylene group having 2 to 3 carbon atoms or mixtures thereof, each R¹ radical is an alkyl or hydroxyalkyl group having 1 to 3 carbon atoms or a polyethylene oxide group having 1 to 3 ethylene oxide units, and x is a number from 0 to 10.

### Fatty Acid Amides:

Fatty acid amides have the formula

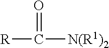

in which R is an alkyl group having 7 to 21, preferably 9 to 17, carbon atoms and each R¹ radical is hydrogen, C₁-C₄-alkyl, C₁-C₄-hydroxyalkyl or (C₂H₄O)ₓH where x is from 1 to 3. Preference is given to C₈-C₂₀ amides, monoethanolamides, diethanolamides and isopropanolamides.

Further suitable nonionic surfactants are alkyl and alkenyl oligoglycosides, and also fatty acid polyglycol esters or fatty amine polyglycol esters each having 8 to 20, preferably 12 to 18, carbon atoms in the fatty alkyl radical, alkyl oligoglycosides, alkenyl oligoglycosides and fatty acid N-alkylglucamides.

Typical examples of amphoteric or zwitterionic surfactants are alkyl betaines, alkylamide betaines, aminopropionates, aminoglycinates or amphoteric imidazolinium compounds of the formula

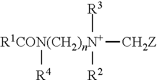

in which R¹ is C₈-C₂₂-alkyl or -alkenyl, R² is hydrogen or CH₂CO₂M, R³ is CH₂CH₂OH or CH₂CH₂OCH₂CH₂CO₂M, R⁴ is hydrogen, CH₂CH₂OH or CH₂CH₂COOM, Z is CO₂M or CH₂CO₂M, n is 2 or 3, preferably 2, M is hydrogen or a cation such as alkali metal, alkaline earth metal, ammonium or alkanol-ammonium.

Preferred amphoteric surfactants of this formula are monocarboxylates and dicarboxylates. Examples thereof are cocoamphocarboxypropionate, cocoamidocarboxypropionic acid, cocoamphocarboxyglycinate (also referred to as cocoamphodiacetate) and cocoamphoacetate.

Further preferred amphoteric surfactants are alkyl dimethylbetaines and alkyl dipolyethoxybetaines having an alkyl radical having 8 to 22 carbon atoms, which may be linear or branched, preferably having 8 to 18 carbon atoms and more preferably having 12 to 18 carbon atoms. These compounds are marketed, for example, by Clariant under the Genagen® LAB trade name.

Suitable cationic surfactants are substituted or unsubstituted straight-chain or branched quaternary ammonium salts of the R¹N(CH₃)₃^{ρ}X^{σ}R¹R²N(CH₃)₂^{ρ}X^{σ}, R¹R²R³N(CH₃)^{ρ}X^{σ} or R¹R²R³R⁴N^{ρ}X^{σ} type. The R¹, R², R³ and R⁴ radicals may preferably independently be unsubstituted alkyl having a chain length between 8 and 24 carbon atoms, especially between 10 and 18 carbon atoms, hydroxyalkyl having 1 to 4 carbon atoms, phenyl, C₂- to C₁₈-alkenyl, C₇- to C₂₄-aralkyl, (C₂H₄O)ₓH where x is from 1 to 3, alkyl radicals containing one or more ester groups, or cyclic quaternary ammonium salts. X is a suitable anion.

Useful emulsifiers include addition products of 0 to 30 mol of alkylene oxide, especially ethylene oxide, propylene oxide and/or butylene oxide, onto linear or branched, saturated or unsaturated fatty alcohols having 8 to 22 carbon atoms, onto fatty acids having 12 to 22 carbon atoms, onto alkylphenols having 8 to 15 carbon atoms in the alkyl group and onto sorbitan esters;

(C₁₂-C₁₈) fatty acid mono- and diesters of addition products of 0 to 30 mol of ethylene oxide onto glycerol;

glyceryl mono- and diesters and sorbitan mono- and diesters of saturated and unsaturated fatty acids having 6 to 22 carbon atoms, and optionally the ethylene oxide addition products thereof;
addition products of 5 to 60 mol, preferably 15 to 60 mol, of ethylene oxide onto castor oil and/or hydrogenated castor oil;
polyol and especially polyglycerol esters, for example polyglyceryl polyricinoleate and polyglyceryl poly-12-hydroxystearate.

In addition, it is possible to use anionic emulsifiers, such as ethoxylated and nonethoxylated mono-, di- or triphosphoric esters, but also cationic emulsifiers such as mono-, di- and trialkyl quats and polymeric derivatives thereof.

Likewise suitable are mixtures of compounds from two or more of these substance classes.

Further ingredients which may be present in the liquid washing compositions include inorganic and/or organic builders in order to reduce the hardness level of the water.

These builders may be present in the liquid washing compositions with proportions by weight of about 5% to about 80%. Inorganic builders include, for example, alkali metal, ammonium and alkanolammonium salts of polyphosphates, for instance tripolyphosphates, pyrophosphates and vitreous polymeric metaphosphates, phosphonates, silicates, carbonates including bicarbonates and sesquicarbonates, sulfates and aluminosilicates.

Examples of silicate builders are the alkali metal silicates, especially those having an SiO₂:Na₂O ratio between 1.6:1 and 3.2:1, and sheet silicates, for example sodium sheet silicates, as described in U.S. Pat. No. 4,664,839, available from Clariant under the SKS® brand. SKS-6® is a particularly preferred sheet silicate builder.

Aluminosilicate builders are particularly preferred. These are especially zeolites having the formula Na_{z}[(AlO₂)_{z}(SiO₂)_{y}].xH₂O in which z and y are integers of at least 6, the ratio of z to y is from 1.0 to 0.5, and x is an integer from 15 to 264.

Suitable ion exchangers based on aluminosilicate are commercially available. These aluminosilicates may be of crystalline or amorphous structure, and may be naturally occurring or else may have been synthetically produced.

Preferred ion exchangers based on synthetic crystalline aluminosilicates are obtainable under the zeolite A, zeolite P(B) (including that disclosed in EP-A-0 384 070) and zeolite X names.

Suitable organic builders include polycarboxyl compounds, for example ether polycarboxylates and oxydisuccinates, as described, for example, in U.S. Pat. No. 3,128,287 and U.S. Pat. No. 3,635,830. Reference should likewise be made to “TMS/TDS” builders from U.S. Pat. No. 4,663,071.

Other suitable builders include the ether hydroxypoly-carboxylates, copolymers of maleic anhydride with ethylene or vinyl methyl ether, 1,3,5-trihydroxybenzene-2,4,6-trisulfonic acid and carboxymethyloxysuccinic acid, the alkali metal, ammonium and substituted ammonium salts of polyacetic acids, for example ethylenediaminetetraacetic acid and nitrilotriacetic acid, and also polycarboxylic acids such as mellitic acid, succinic acid, oxydisuccinic acid, polymaleic acid, benzene-1,3,5-tricarboxylic acid, carboxymethyloxysuccinic acid, and the soluble salts thereof.

Citrate-based builders, for example citric acid and the soluble salts thereof, especially the sodium salt, are preferred polycarboxylic acid builders, which can also be used in granulated formulations, especially together with zeolites and/or sheet silicates.

Further suitable builders are the 3,3-dicarboxy-4-oxa-1,6-hexanedioates and the related compounds disclosed in U.S. Pat. No. 4,566,984.

When phosphorus-based builders can be used, it is possible to use various alkali metal phosphates, for instance sodium tripolyphosphate, sodium pyrophosphate and sodium orthophosphate. It is likewise possible to use phosphonate builders, such as ethane-1-hydroxy-1,1-diphosphonate and other known phosphonates as disclosed, for example, in U.S. Pat. No. 3,159,581, U.S. Pat. No. 3,213,030, U.S. Pat. No. 3,422,021, U.S. Pat. No. 3,400,148 and U.S. Pat. No. 3,422,137.

The liquid washing compositions may optionally comprise one or more conventional bleaches, and also activators or stabilizers, especially peroxy acids.

The peroxy acid may either be a free peroxy acid or a combination of an inorganic per salt, for example sodium perborate or sodium percarbonate, and an organic peroxy acid precursor which is converted to a peroxy acid when the combination of the per salt and the peroxy acid precursor is dissolved in water. The organic peroxy acid precursors are often referred to as bleach activators.

Examples of preferred peroxy acids include peroxydodecanedioic acid (DPDA), the nonylamide of peroxysuccinic acid (NAPSA), the nonylamide of peroxyadipic acid (NAPAA) and decyldiperoxysuccinic acid (DDPSA).

The peroxy acid-containing bleach is used in amounts in which it is typically used in liquid washing compositions.

Suitable amounts of peroxy acid-containing bleach, based on a unit dose of a liquid washing composition as used for a typical wash liquor, which comprises about 10-15 liters of water at 5 to 60° C., produce from about 1 ppm to about 150 ppm of available oxygen, preferably from about 2 ppm to about 20 ppm of available oxygen. The wash liquor should have a pH of preferably 7 to 12 and more preferably of 8 to 11, in order to achieve an adequate bleaching outcome.

Alternatively, the bleach composition may comprise a suitable organic peroxy acid precursor which produces one of the abovementioned peroxy acids when it reacts with hydrogen peroxide in aqueous alkaline solution. The source of the hydrogen peroxide may be any inorganic peroxide which releases hydrogen peroxide in aqueous solution, for instance sodium perborate (monohydrate and tetrahydrate) and sodium percarbonate.

Available bleach activators include N,N,N′,N′-tetraacetylethylenediamine (TAED), glucose pentaacetate (GPA), xylose tetraacetate (TAX), sodium 4-benzoyloxybenzenesulfonate (SBOBS), sodium trimethyl-hexanoyloxybenzenesulfonate (STHOBS), tetraacetylglycoluril (TAGU), tetraacetylcyanic acid (TACA), di-N-acetyldimethylglyoxine (ADMG) and 1-phenyl-3-acetylhydantoin (PAH), nonanoylcaprolactam phenylsulfonate ester (APES), nonanoylphenyl sulfonate ester (NOPS), nitrilotriacetate (NTA) and ammonionitriles.

Sequestrants available include sodium tripolyphosphate (STPP), ethylenediaminetetraacetic acid (EDTA), salts, nitrilotriacetic acid (NTA), polyacrylate, phosphonate, oxalic acid, salt, citric acid, zeolite, condensed phosphates, carbonates, polycarbonates.

Suitable soil release polymers (SRPs) are polyesters obtainable by polymerizing the components selected from one or more sulfo-free aromatic dicarboxylic acids and/or salts thereof, one or more sulfo-containing dicarboxylic acids, one or more compounds of the formula R¹O(CHR²CHR³O)ₙH where R¹ is a linear or branched alkyl or alkenyl group having 1 to 22 carbon atoms, preferably C₁-C₄-alkyl and more preferably methyl, R² and R³ are each independently hydrogen or an alkyl group having 1 to 4 carbon atoms, preferably hydrogen and/or methyl, and n is a number from 1 to 100, one or more compounds of the formula H—(OCH₂CH₂)ₘ—SO₃X where m is a number from 1 to 100 and X is hydrogen or an alkali metal ion, and one or more crosslinking polyfunctional compounds.

The SRPs may be present in amounts of 0.1 to 10% by weight and preferably in amounts of 0.2 to 3% by weight, based on the finished liquid washing compositions.

Useful graying inhibitors include carboxymethyl cellulose, methyl cellulose, hydroxyalkyl cellulose, methyl hydroxyethyl cellulose, methyl hydroxypropyl cellulose, methyl carboxymethyl cellulose and polyvinylpyrrolidone.

Useful dye transfer inhibitors include, for example, polyamine N-oxides, for instance poly(4-vinylpyridine N-oxide), e.g. Chromabond S-400, from ISP; polyvinylpyrrolidone, e.g. Sokalan® HP 50, from BASF, and copolymers of N-vinylpyrrolidone with N-vinylimidazole and optionally other monomers.

The liquid washing compositions may also comprise dye fixatives as active substances, for example dye fixatives which are obtained by reacting diethylenetriamine, dicyandiamide and amidosulfuric acid, amines with epichlorohydrin, for example dimethylaminopropylamine and epichlorohydrin or dimethylamine and epichlorohydrin or dicyandiamide, formaldehyde and ammonium chloride, or dicyandiamide, ethylenediamine and formaldehyde or cyanamide with amines and formaldehyde or polyamines with cyanamides and amidosulfuric acid or cyanamides with aldehydes and ammonium salts, but also polyamine N-oxides, for instance poly(4-vinylpyridine N-oxide), e.g. Chromabond S-400, from ISP; polyvinylpyrrolidone, e.g. Sokalan® HP 50, from BASF, and copolymers of N-vinylpyrrolidone with N-vinylimidazole and optionally other monomers.

The liquid washing compositions may comprise complexing agents, for example aminocarboxylates such as ethylenediaminetetraacetate, N-hydroxyethylethylenediaminetriacetate, nitrilotriacetate, ethylenediamine-tetrapropionate, triethylenetetraaminehexaacetate, diethylenetriaminepentaacetate, cyclohexanediaminetetraacetate, phosphonates, for example azacycloheptanediphosphonate, sodium salt, pyrophosphates, etidronic acid (1-hydroxyethylidene-1,1-diphosphonic acid, 1-hydroxyethane-1,1-diphosphonic acid, aceto-phosphonic acid) and salts thereof, aminophosphonates, such as ethylenediaminetetrakis(methylenephosphonate), diethylenetriaminepentakis(methylenephosphonate), aminotrimethylenephosphonic acid, cyclodextrins, and polyfunctionally substituted aromatic complexing agents such as dihydroxydisulfobenzene or ethylene-diaminedisuccinates.

The optical brighteners used may be cyclic hydrocarbons such as distyrylbenzenes, distyrylbiphenyls, diphenylstilbenes, triazinylaminostilbenes, stilbenzyl-2H-triazoles, for example stilbenzyl-2H-naphthol[1,2-d]triazoles and bis(1,2,3-triazol-2-yl)stilbenes, benzoxazoles, for example stilbenzylbenzoxazole and bis(benzoxazole), furans, benzofurans and benzimidazoles, for example bis(benzo[b]furan-2-yl)biphenyl and cationic benzimidazoles, 1,3-diphenyl-2-pyrazoline, coumarin, naphthalimides, 1,3,5-2-yl derivatives, methinecyanine and dibenzothiophene 5,5-oxide.

Preference is given to anionic optical brighteners, especially sulfonated compounds.

Additionally useful are triazinylaminostilbenes, distyrylbiphenyls and mixtures thereof, 2-(4-styrylphenyl)-2H-naphtho[1,2-d]triazole, 4,4′-bis-(1,2,3-triazol-2-yl)stilbene, aminocoumarin, 4-methyl-7-ethylaminocoumarin, 1,2-bis(benzimidazol-2-yl)ethylene, 1,3-diphenylphrazoline, 2,5-bis(benzoxazol-2-yl)thiophenes, 2-styrylnaphtho[1,2-d]oxazole, 2-(4-styryl-3-sulfophenyl)-2H-naphtho[1,2-d]triazole and 2-(stilben-4-yl)-2H-naphtho[1,2-d]triazole.

The liquid washing compositions may contain optical brighteners in amounts of 0.001 to 2% by weight, preferably in amounts of 0.002 to 0.8% by weight and more preferably in amounts of 0.003 to 0.4% by weight.

The softening components used are quaternary ammonium salts of the type

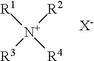

in which
R¹=C₈-C₂₄ n- or isoalkyl, preferably C₁₀-C₁₈ n-alkyl,
R²=C₁-C₄-alkyl, preferably methyl,
R³=R¹ or R²,
R⁴=R² or hydroxyethyl or hydroxypropyl or oligomers thereof and
X⁻=bromide, chloride, iodide, methosulfate, acetate, propionate or lactate.

Examples thereof are distearyldimethylammonium chloride, ditallowalkyldimethylammonium chloride, ditallowalkylmethylhydroxypropylammonium chloride, cetyltrimethylammonium chloride or else the corresponding benzyl derivatives such as dodecyldimethylbenzylammonium chloride. Cyclic quaternary ammonium salts, for instance alkyl-morpholine derivatives, can likewise be used.

In addition, as well as the quaternary ammonium compounds, it is possible to use imidazolinium compounds (1) and imidazoline derivatives (2)

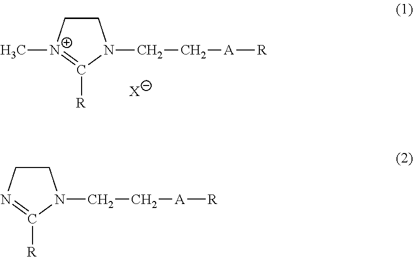

in which
R=C₈-C₂₄ n- or isoalkyl, preferably C₁₀-C₁₈ n-alkyl,
X=bromide, chloride, iodide or methosulfate, and
A=—NH—CO—, —CO—NH—, —O—CO— or —CO—O—.

A particularly preferred compound class is that of the so-called ester quats. These are reaction products of alkanolamines and fatty acids, which are subsequently quaternized with customary alkylating or hydroxyalkylating agents.

Examples of ester quats are compounds of the formulae:

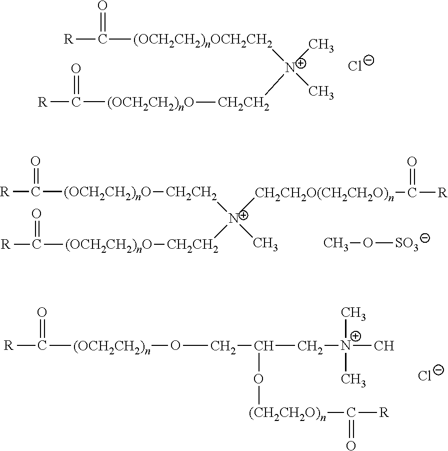

where R—C—O is derived from C₈-C₂₄ fatty acids which may be saturated or unsaturated. n is in the range from 0 to 10, preferably in the range from 0 to 3 and more preferably in the range from 0 to 1.

Further preferred laundry fabric softener raw materials are amido amines based on, for example, dialkyltriamines and long-chain fatty acids, and the ethoxylates or quaternized variants thereof. These compounds have the following structure:

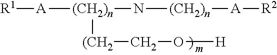

in which
R¹ and R² are each independently C₈-C₂₄ n- or isoalkyl, preferably C₁₀-C₁₈ n-alkyl,
A is —CO—NH— or —NH—CO—,
n is 1 to 3, preferably 2, and
m is 1 to 5, preferably 2 to 4.

By quaternizing the tertiary amino group, it is additionally possible to introduce an R³ radical, which may be C₁-C₄-alkyl, preferably methyl, and a counterion X, which may be chloride, bromide, iodide or methyl-sulfate. Amido amino ethoxylates or the quaternized conversion products thereof are supplied under the Varisoft® 510, Varisoft® 512, Rewopal® V 3340 and Rewoquat® W 222 LM trade names.

The liquid washing compositions preferably comprise dyes and fragrances or perfumes.

Preferred dyes are Acid Red 18 (CI-16255), Acid Red 26, Acid Red 27, Acid Red 33, Acid Red 51, Acid Red 87, Acid Red 88, Acid Red 92, Acid Red 95, Acid Red 249 (CI-18134), Acid Red 52 (CI-45100), Acid Violet 126, Acid Violet 48, Acid Violet 54, Acid Yellow 1, Acid Yellow 3 (CI-47005), Acid Yellow 11, Acid Yellow 23 (CI-19140), Acid Yellow 3, Direct Blue 199 (CI-74190), Direct Yellow 28 (CI-19555), Food Blue 2 (CI-42090), Food Blue 5:2 (CI-42051:2), Food Red 7 (CI-16255), Food Yellow 13 (CI-47005), Food Yellow 3 (CI-15985), Food Yellow 4 (CI-19140), Reactive Green 12, Solvent Green 7 (CI-59040).

Particularly preferred dyes are water-soluble acid dyes, for example Food Yellow 13 (Acid Yellow 3, CI-47005), Food Yellow 4 (Acid Yellow 23, CI-19140), Food Red 7 (Acid Red 18, CI-16255), Food Blue 2 (Acid Blue 9, CI-42090), Food Blue 5 (Acid Blue 3, CI-42051), Acid Red 249 (CI-18134), Acid Red 52 (CI-45100), Acid Violet 126, Acid Violet 48, Acid Blue 80 (CI-61585), Acid Blue 182, Acid Blue 182, Acid Green 25 (CI-61570), Acid Green 81.

Equally, it is also possible with preference to use water-soluble direct dyes, for example Direct Yellow 28 (CI-19555), Direct Blue 199 (CI-74190) and water-soluble reactive dyes, for example Reactive Green 12, and the dyes Food Yellow 3 (CI-15985), Acid Yellow 184.

Equally, it is possible with preference to use aqueous dispersions of the pigment dyes which follow, the concentration of the dye dispersions used to color solutions or dispersions being in the range from 0.1 to 50% by weight, preferably in the range from 1 to 45% by weight, more preferably in the range from 5 to 40% by weight and especially preferably in the range from 10 to 35% by weight.

The person skilled in the art is aware that the aqueous pigment dispersions, as well as the pigments, dispersants and optionally further auxiliaries, comprise, for example, biocides.

Useful pigment dyes include Pigment Black 7 (CI-77266), Pigment Blue 15 (CI-74160), Pigment Blue 15:1 (CI-74160), Pigment Blue 15:3 (CI-74160), Pigment Green 7 (CI-74260), Pigment Orange 5, Pigment Red 112 (CI-12370), Pigment Red 112 (CI-12370), Pigment Red 122 (CI-73915), Pigment Red 179 (CI-71130), Pigment Red 184 (CI-12487), Pigment Red 188 (CI-12467), Pigment Red 4 (CI-12085), Pigment Red 5 (CI-12490), Pigment Red 9, Pigment Violet 23 (CI-51319), Pigment Yellow 1 (CI-11680), Pigment Yellow 13 (CI-21100), Pigment Yellow 154, Pigment Yellow 3 (CI-11710), Pigment Yellow 74, Pigment Yellow 83 (CI-21108), Pigment Yellow 97.

In preferred embodiments, the following pigment dyes are used in the form of dispersions: Pigment Yellow 1 (CI-11680), Pigment Yellow 3 (CI-11710), Pigment Red 112 (CI-12370), Pigment Red 5 (CI-12490), Pigment Red 181 (CI-73360), Pigment Violet 23 (CI-51319), Pigment Blue 15:1 (CI-74160), Pigment Green 7 (CI-74260), Pigment Black 7 (CI-77266).

In further preferred embodiments, water-soluble polymer dyes, for example Liquitint™, Liquitint Blue HP™, Liquitint Blue 65™, Liquitint Patent Blue™, Liquitint Royal Blue™, Liquitint Experimental Yellow 8949-43™, Liquitint Green HMC™, Liquitint Yellow II™. and mixtures thereof, are used.

Fragrances or perfumes which may be used are individual odorant compounds, for example the synthetic products of the ester, ether, aldehyde, ketone, alcohol and hydrocarbon types. Odorant compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethyl methylphenyl glycinate, allylcyclohexyl propionate, styrallyl propionate and benzyl salicylate. The ethers include, for example, benzyl ethyl ethers, the aldehydes include, for example, the linear alkanals having 8 to 18 carbon atoms, citral, citronellal, citronellyloxyacetaldehyde, hydroxycitronellal, lilial and bourgeonal, the ketones include, for example, the ionones, alpha-isomethylionone and methyl cedryl ketone, the alcohols include anethol, citronellol, eugenol, geraniol, linalool, phenylethyl alcohol and terpineol, and the hydrocarbons include primarily the terpenes and balsams. Preference is given to using mixtures of different odorants which together produce a pleasing fragrance note.

Perfume oils may also comprise natural odorant mixtures, as obtainable from vegetable or animal sources, e.g. pine oil, citrus oil, jasmine oil, lily oil, rose oil or ylang-ylang oil. Essential oils of relatively low volatility which are usually used as aromatic components are also suitable as perfume oils, for example sage oil, chamomile oil, clove oil, melissa oil, mint oil, cinnamon leaf oil, linden blossom oil and juniperberry oil.

It is preferable to use solutions or emulsions of the above-mentioned fragrances and perfume oils, which can be produced by standard methods.

In a preferred embodiment of the invention, the liquid washing compositions, as well as the one or more secondary paraffinsulfonates and the amylase, comprise one or more surfactants (other than the secondary paraffinsulfonates).

The wash temperature when the liquid washing compositions are used for cleaning of the starch-containing stains on textiles is preferably from 5 to 60° C., more preferably from 10 to 50° C. and especially preferably from 20 to 40° C. The cleaning capacity of the liquid washing compositions with respect to starch-containing stains on textiles is thus increased when said liquid washing compositions for textiles are used, preferably at wash temperatures from 5 to 60° C., more preferably from 10 to 50° C. and especially preferably from 20 to 40° C.

Preferably, the inventive use takes place at a pH of 7 to 12 and more preferably at a pH of 8 to 11.

In the case of the inventive use in liquid washing compositions for textiles, the amount of the one or more secondary paraffinsulfonates used in accordance with the invention is preferably from 5 to 30% by weight, more preferably from 7 to 25% by weight and especially preferably from 10 to 20% by weight, based in each case on the total weight of the finished liquid washing compositions.

In the case of the inventive use in liquid washing compositions for textiles, the amount of amylase is preferably at least 0.001% by weight, more preferably from 0.001 to 8% by weight, especially preferably from 0.01 to 3% by weight and exceptionally preferably from 0.1 to 2% by weight, based in each case on the total weight of the finished liquid washing compositions.

In the case of the inventive use, the total surfactant concentration in the wash liquor is preferably from 0.08 to 0.30% by weight, more preferably from 0.09 to 0.20% by weight, especially preferably from 0.10 to 0.15% by weight and exceptionally preferably from 0.11 to 0.13% by weight, based in each case on the total weight of the wash liquor.

The examples which follow are intended to illustrate the invention without restricting it thereto. All percentages should, unless explicitly stated otherwise, be understood as percent by weight (% by weight).

Wash tests were conducted with the following formulations.

### Formulation A

highly concentrated, dosage 37 ml in 12 liters of water

| | | % by wt. |
|---|---|---|
| Composition | | (active substance) |
| A | Edenor K 12-18 | 5 |
| | coconut fatty acid | |
| | water | to 100 |
| B | KOH (85% by weight) | 0.8 |
| C | Hostapur ® SAS 60 | 18 |
| | sec. sodium paraffinsulfonate | |
| | Genapol ® LRO paste (Clariant) | 2 |
| | active substance: lauryl ether sulfate, 2 EO | |
| | (EO: ethylene oxide unit), Na salt | |
| | Genapol ® OX 070 (Clariant) | 13 |
| | C12,15-oxo alcohol, 7 EO | |
| | Cublen ® BIT 121 | 2 |
| | phosphonate | |
| | trisodium citrate dihydrate | 3.5 |
| | Texcare ® SRN 170 | 1 |
| | nonionic polyester of polypropylene | |
| | terephthalate, aqueous | |
| | propanediol | 10 |
| | ethanol | 2 |
| | Leucophor ® BSB | 0.5 |
| | optical brightener | |
| D | Liquanase Ultra 2,0 XL | 3.0 |
| | protease | |
| | Stainzyme Plus 12 L | 1.5 |
| | amylase | |
| | Mannaway 4,0 L | 0.6 |
| | mannase | |
| | Lipex 100L | 0.5 |
| | lipase | |
| | Endolase 5000L | 0.6 |
| | endolase | |

### Formulation B

highly concentrated, dosage 37 ml in 12 liters of water

Instead of Hostapur® SAS 60 in formulation A, 18% by weight of active substance from Marlon® A 360 (linear alkylbenzenesulfonate, Na salt) were added.

### Formulation I

standard concentrate, dosage 75 ml in 12 liters of water

| | |
|---|---|
| | % by wt. |
| Composition | (active substance) |

| | | |
|---|---|---|
| A | Edenor K 12-18 | 2 |
| | coconut fatty acid | |
| | water | to 100 |
| B | triethanolamine | 2 |
| C | Hostapur ® SAS 60 | 15 |
| | sec. sodium paraffinsulfonate | |
| | Genapol ® OX 070 (Clariant) | 18 |
| | C12,15-oxo alcohol, 7 EO | |
| | Cublen ® BIT 121 | 2 |
| | phosphonate | |
| | trisodium citrate dihydrate | 3 |
| | propanediol | 8 |
| | ethanol | 4 |
| | Leucophor ® BSB | 0.5 |
| | optical brightener | |
| D | Liquanase Ultra 2,0 XL | 3.0 |
| | protease | |
| | Stainzyme Plus 12 L | 1.5 |
| | amylase | |
| | Mannaway 4,0 L | 0.6 |
| | mannase | |
| | Lipex 100L | 0.5 |
| | lipase | |
| | Endolase 5000L | 0.6 |
| | endolase | |

### Formulation II

standard concentrate, dosage 75 ml in 12 liters of water

Instead of Hostapur® SAS 60 in formulation I, 15% by weight of active substance from Marlon® A 360 (linear alkylbenzenesulfonate, Na salt) were added.

### Preparation of Formulations A, B, I and II:

I Addition of components B to A with stirring at room temperature.

II Successive addition of components C to I with stirring.

III Successive addition of components D to II with stirring.

Hostapur® SAS 60 is a composition of secondary sodium paraffinsulfonate (about 60% by weight) in water. The secondary paraffinsulfonate used contains about 97% by weight of paraffinsulfonates having 14 to 17 carbon atoms. The n-paraffin component of the secondary paraffinsulfonate is >98% by weight. The secondary paraffinsulfonate is 100% saturated. It consists to an extent of about 90% by weight of monosulfonated and to an extent of about 10% by weight of disulfonated and higher sulfonated paraffinsulfonates.

The wash tests were conducted under the following conditions:

Washing machine: Siemens S 16-79

Program: standard/color

Load: 3 kg

Temperature: 20° C.

Spin: 1400 revolutions/minute

Water volume: 12 liters

The differences in the reflectance values AR 457 nm between washed and unwashed textiles were measured. The soiled textiles measured are commercially available. The following 17 textiles/stains were measured: WFK 20 PF pigment/vegetable fat, WFK 10 N whole egg/pigment, CS 6 salad dressing with natural black, CS 73 guar flour/pigment, CS 10 stained with butter grease, CS 27 stained with potato starch, CS 28 stained with rice starch, CS 8 grass, PC 3 chocolate/milk/soot, C 3 chocolate/milk/soot, CS 1 aged blood, C 5 blood/milk/indian ink, EMPA 162 starch, EMPA 164 grass, EMPA 112 cocoa, EMPA 117 blood/milk/indian ink and EMPA 116 blood/milk/indian ink.

### Measurement:

Instrument: Elrepho 3000 (Datacolor)

Aperture: XLAV 034 mm

Edge filter: 400 nm

The measurements were undertaken directly after production of the formulations.

Table A below lists the differences in the reflectance values ΔR 457 nm measured over all 4 individual starch-containing stains. In addition, the sum of the measured differences in the reflectance values ΔR 457 nm for the 4 starch-containing stains and the sum of the measured differences in the reflectance values ΔR 457 nm for all 17 stains are listed. In addition, table A lists the percentage changes in the reflectance values ΔR 457 nm (ΔR−%) calculated by the following formula:

Percentage change=[ΔR 457 nm (with enzyme):ΔR 457 nm (without enzyme)]*100

For the measurements, formulations A and B with enzyme and the analogous formulations A′ and B′ without enzyme were used.

TABLE A
Measured ΔR 457 nm values and ΔR - % values

| | ΔR 457 nm | ΔR 457 nm | | ΔR 457 nm | ΔR 457 nm | |
|---|---|---|---|---|---|---|
| | SAS | SAS | | LAS | LAS | |
| | without | with | ΔR - % | without | with | ΔR - % |
| Stain | enzyme | enzyme | SAS | enzyme | enzyme | LAS |
| EMPA 162 | 6.5 | 31 | 477 | 7.6 | 28.3 | 372 |
| starch | | | | | | |
| CS 28 stained | 16.0 | 36.0 | 225 | 15.7 | 31.4 | 200 |
| with rice starch | | | | | | |
| CS 27 stained | 12.3 | 30.2 | 246 | 12.7 | 22.4 | 176 |
| with potato | | | | | | |
| starch | | | | | | |
| CS 73 guar | 7.0 | 23.4 | 334 | 6.5 | 21.1 | 308 |
| flour/pigment | | | | | | |
| all 4 starch- | 41.8 | 120.6 | 289 | 42.5 | 103.2 | 243 |
| containing | | | | | | |
| stains | | | | | | |
| all 17 stains | 248 | 470 | 190 | 253 | 418 | 165 |

SAS: secondary paraffinsulfonate;
LAS: linear alkylbenzenesulfonate

Formulations A′ and B′ without enzyme can be produced like formulations A, B, I and II, in which case, however, the preparation is ended after step II.

The formulations A and B used for the measurements comprise several enzymes. The person skilled in the art is aware that amylase degrades polysaccharides, for example starch.

The percentage changes in the reflectance values ΔR 457 nm (ΔR−%) give a measure for the increase in the cleaning capacity of a combination of SAS with enzyme compared to SAS without enzyme, or for the increase in the cleaning capacity of a combination of LAS with enzyme compared to LAS without enzyme.

It is apparent from the results in table A that the combination of SAS with enzyme leads to higher ΔR−% values with respect to starch-containing stains than the combination of LAS with enzyme.

It is additionally apparent from the results in table A that the ΔR−% value for the combination of SAS with enzyme with respect to all 4 starch-containing stains is higher than the ΔR−% value for the combination of SAS with enzyme with respect to all 17 stains (cf. ΔR−% values 289 and 190 from table A).

For CS 1 aged blood, the following measurements were determined as for the values shown in table A: ΔR 457 nm SAS without enzyme=19.8 and ΔR 457 nm SAS with enzyme=26.7, which gives ΔR−% SAS=135. Compared to the results in table A, it is apparent that the ΔR−% values for the combination of SAS with enzyme with respect to the starch-containing stains are higher than the ΔR−% value for the combination of SAS with enzyme with respect to the “aged blood” stain. The other blood-containing stains were not included in this comparison because they are mixtures of stains (blood/milk/indian ink).

1. In a method of washing textiles with a liquid washing composition to remove starch-containing stains, the improvement comprising providing combination of one or more secondary paraffinsulfonates having 8 to 22 carbon atoms and amylase to the cleaning composition for increasing the cleaning capacity of the liquid washing compositions with respect to the starch-containing stains on the textiles.

2. The improvement as claimed in claim 1, wherein at least 95% by weight of the one or more secondary paraffinsulfonates contain 14 to 17 carbon atoms.

3. The improvement as claimed in claim 1, wherein 95 to 100% by weight of the one or more secondary paraffinsulfonates contain a linear paraffin moiety and 0 to 5% by weight of the one or more secondary paraffinsulfonates a branched paraffin moiety.

4. The improvement as claimed in claim 1, wherein the counterions of the one or more secondary paraffinsulfonates are selected from the group consisting of Na⁺, Mg²⁺ and Ca²⁺.

5. The improvement as claimed in claim 4, wherein the counterion of the one or more secondary paraffinsulfonates is Na⁺.

6. The improvement as claimed in claim 1, wherein 100% by weight of the one or more secondary paraffinsulfonates contain a saturated paraffin moiety.

7. The improvement as claimed in of claim 1, wherein the sulfonate groups are distributed randomly over the nonterminal paraffin moiety of the one or more secondary paraffinsulfonates, and from 75 to 95% by weight of the one or more secondary paraffinsulfonates bear one sulfonate group and from 5 to 25% by weight of the one or more secondary paraffinsulfonates two or more sulfonate groups.

8. The improvement as claimed in claim 1, wherein the cleaning capacity of the liquid washing compositions at wash temperatures of 5 to 60° C. is increased.

9. The improvement as claimed in claim 1, wherein the amount of the one or more secondary paraffinsulfonates in the liquid washing compositions is from 5 to 30% by weight.

10. The improvement as claimed in claim 1, wherein the amount of amylase in the liquid washing compositions is from 0.001 to 8% by weight.
